(19) United States
(12) Patent Application Publication
(10) Pub. No.: US 2024/0303499 A1
(43) Pub. Date: Sep. 12, 2024

(54) METHOD FOR OPTIMIZING WORKFLOW-BASED NEURAL NETWORK INCLUDING ATTENTION LAYER

(71) Applicant: Hong Kong Applied Science and Technology Research Institute Company Limited, Hong Kong (HK)

(72) Inventors: Wai Kai Arvin TANG, Hong Kong (HK); Kai Kin CHAN, London (GB)

(21) Appl. No.: 18/179,398

(22) Filed: Mar. 7, 2023

(51) Int. Cl. G06N 3/092

(52) U.S. Cl. CPC G06N 3/092

(57) ABSTRACT

A method for optimizing a workflow-based neural network including an attention layer is provided. The method comprises: training the workflow-based neural network to predict a result from input elements under a prediction model with the attention layer assigning attention placements and weights, based on an original attention function, to the input elements; obtaining an original attention mask pattern and a proposed attention mask pattern; creating an attention mask updating function based on the original attention mask pattern and the proposed attention mask pattern; and combining the attention mask updating function with the original attention function to form an updated attention function.

### FIELD OF THE INVENTION

The present invention generally relates to artificial intelligence and deep learning technologies. More specifically, the present invention relates to workflow-based neural network optimization techniques.

### BACKGROUND OF THE INVENTION

When training a neural network of a machine learning (ML) model, there is limited knowledge on what features are learnt by the ML model. In cases of inaccurate prediction results, the output of the ML model provides little information to engineers to make educated guesses of what is wrong with the model or the training data. As such, it always takes a long time and consume massive resources in model optimization.

Attention layers are widely used in transformer models to perform various tasks such as optical character recognition. By using an attention layer, a transformer model places more focus (or attention weights) on certain regions of an input in the attempt to increase accuracy in the prediction results.

For example, a deep learning model implemented with a convolutional neural network (CNN) and a vanilla transformer decoder with one or more attention layers there within may be trained to predict a correct sequence of three characters “a”, “b” and “c” in a text image. As show in FIG. 1, at time t=1, the model has correctly predicted “b” for the first character, yet attention weights are placed on both characters “b” and “a”, which makes little sense; at time t=2, the model has correctly predicted “a” for the second character even though attention weights are placed on the wrong character “b”; at time t=3, similar misalignment between the output and attention weight placement is observed. Therefore, in case of incorrect output, it would be difficult to trouble-shoot the model as we do not know what exactly the model is doing.

A number of approaches have been adopted by the industry to improve the performance of attention-layer-inclusive transformer models. Some approaches make use of hyperparameters such as model scale, loss functions, regularizations, optimizer parameters, etc. in the ML model training for applications such as Grid Search, Random Search, and Hand-Tuning. However, most of them demand a resource-intensive trial-and-error process with many possible combinations of hyperparameters in order to arrive at a combination that works best. Although some automation techniques are possible, as the number of combinations grow exponentially with the number of hyperparameters, these approaches may only be used by resourceful organizations.

Some approaches are based on data enhancement techniques such as data collection, data cleaning, and data augmentation. In these approaches, the ML model may be improved significantly by feeding its training with higher quality training data. However, it is often challenging to obtain high quality training data. Data of specific knowledge domains can be scarce; the training dataset can contain hidden inconsistency; and the dataset can contain imbalance data.

Some other approaches are based on architecture innovation where the model's performance is improved by implementing innovative architectural designs. For example, Chinese Patent publication no. CN114049408A discloses an auxiliary branch of a transformer encoder for aiding its main branch. Some architecture innovations may be effective to improve the ML model performance. However, innovative ideas can be costly and require vast number of experimentations before they can be widely adopted. Innovation is not always commercially viable due to resource and time constraints.

Still some other approaches are based on feature engineering where raw data are analyzed, selected, manipulated, and transformed into specific features. The specific features then are taken as input to the neural networks. The negative effects of outliners may be nullified and unnecessary information may be eliminated. However, most of these approaches depend on trial and error in determining which features work and which ones do not, and they require good domain knowledge. Thus, while these approaches are well received by data scientists, they are not popular with machine learning engineers.

Notwithstanding the above, a common problem with the aforesaid approaches is that a large training dataset is required for training the machine learning models. When the amount training data is limited, the model tends to learn something wrong and its prediction performance suffers. There is a need in the art for a better approach to provide clear directions for engineers to have better insight in the working of machine learning models and allow the injections of human knowledge into the models to correct deficiencies in the learning.

### SUMMARY OF THE INVENTION

It is an objective of the present invention to provide a method for optimizing a work-flow based neural network having an attention layer by injecting human knowledge during its training.

In accordance with one embodiment of the present invention, a method for optimizing a workflow-based neural network having an attention layer is provided. The method comprises: training the workflow-based neural network to predict a result from input elements under a prediction model with the attention layer assigning attention placements and weights, based on an original attention function, to the input elements until the prediction model converges; obtaining an original attention mask pattern and a proposed attention mask pattern; creating an attention mask updating function based on the original attention mask pattern and the proposed attention mask pattern; and combining the attention mask updating function with the original attention function to form an updated attention function.

The generation of the attention mask pattern proposal is an iterative process. It provides insight and useful feedback of the working of the prediction model of the neural network so that human knowledge can be injected through step-by-step eliminations of potential issues with the prediction model. In turn, the neural network's optimization time and cost can be greatly reduced.

### BRIEF DESCRIPTION OF THE DRAWINGS

Embodiments of the invention are described in more detail hereinafter with reference to the drawings, in which:

FIG. 1 depicts a character recognition example performed by a conventional machine learning model;

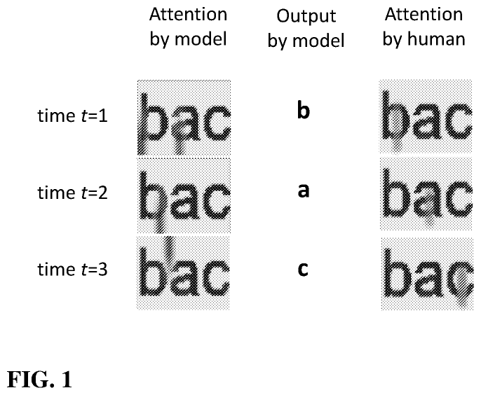

FIG. 2 depicts a flowchart of a method for optimizing a workflow-based neural network which includes an attention layer according to one embodiment of the present invention;

FIG. 3 depicts a functional block diagram of the workflow-based neural network;

FIG. 4 illustrate a flowchart of the generation of attention pattern proposal in accordance to one embodiment;

FIG. 5 illustrates a flowchart of creation of the attention mask updating function in accordance to one embodiment;

FIG. 6 illustrates an exemplary original attention mask pattern on an input image in accordance to one embodiment; and

FIG. 7 illustrates how to obtain a distance in the x-direction between a centroid of attention weights at the previous timestep and a centroid of attention weights at the current timestep.

### DETAILED DESCRIPTION

In the following description, methods of optimizing a neural network and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

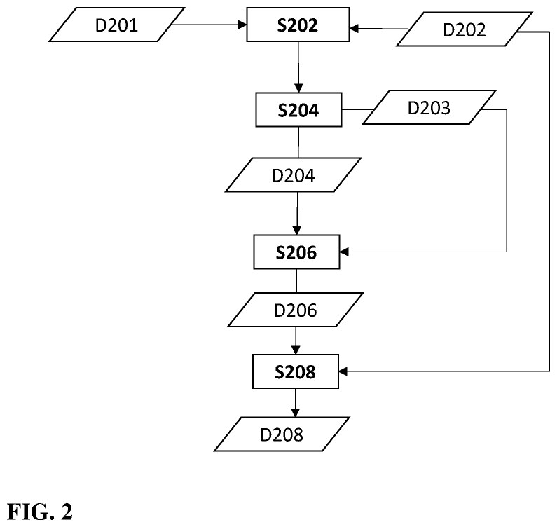

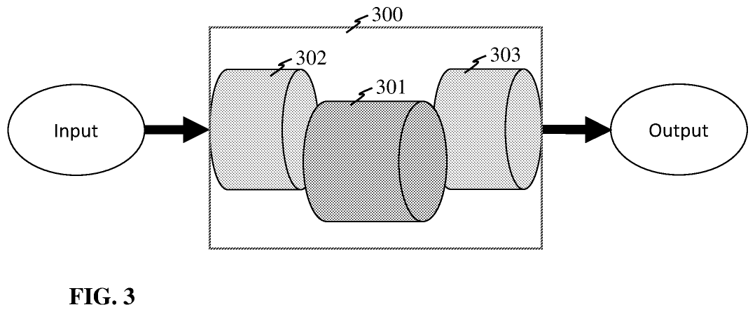

Referring to FIGS. 2 and 3 for the following description. As shown in FIG. 3, a workflow-based neural network 300 in accordance with various embodiments of the present invention comprises an attention layer 301, one or more preceding layers 302 and one or more following layers 303.

In accordance with one embodiment of the present invention, a method for optimizing the workflow-based neural network 300 is provided. The method comprises the following process steps:
S202: training the workflow-based neural network 300 to predict a result from one or more input elements D201 under a prediction model with the attention layer 301 assigning one or more attention placements and weights, based on an original attention function D202, to the input elements D201 until the prediction model converges;
S204: generating an attention mask pattern proposal to obtain an original attention mask pattern D203 and a proposed attention mask pattern D204;
S206: creating an attention mask updating function D206 based on the original attention mask pattern D203 and the proposed attention mask pattern D204; and
S208: combining the attention mask updating function D206 with the original attention function D202 to form an updated attention function D208 of the attention layer 301.

In accordance with one embodiment, the original attention function D202 is a scaled dot-product attention function having input (input vectors) including a key matrix of queries and a key matrix of keys, both of dimension dₖ, and a value matrix of values of dimension dᵥ. Attention weights of the elements are obtained by computing the dot products of the queries and the keys, then dividing each dot product by the square root of dₖ. The obtained attention weights are then applied to the values to obtain the attention function. That is, the original attention function D202 may be expressed as:

$$Attention ( Q , K , V ) = softmax ( \frac{Q {K}^{T}}{\sqrt{{d}_{k}}} ) \cdot V ,$$

where Q represents the key matrix of queries, K represents the key matrix of keys, and V represents the value matrix of values.

The updated attention function D208 may then be expressed as:

$${Attention}^{′} ( Q , K , V ) = f ( softmax ( \frac{Q {K}^{T}}{\sqrt{d}} ) ) \cdot V$$

where ƒ( ) represents the attention mask updating function D206.

In accordance with one embodiment, therefore, the updated attention function D208 of the attention layer 301 is obtained by directly applying the attention mask updating function D206 to the original attention function D202 in the attention layer 301.

In accordance with another embodiment, the updated attention function D208 of the attention layer 301 is obtained by training the workflow-based neural network 300 to learn through backpropagation with an auxiliary loss function defined with the original attention function D202 and the attention mask updating function D206. This way, the attention layer 301 learns the attention mask updating function D206 by itself, incorporating the function within the workflow-based neural network 300. The auxiliary loss function may be expressed as:

$$AuxLoss = Loss ( softmax ( \frac{Q {K}^{T}}{\sqrt{d}} ) , f ( softmax ( \frac{Q {K}^{T}}{\sqrt{d}} ) ) )$$

In embodiments where there are more than one attention layers in the workflow-based neural network 300, the process steps of S204 to S208 are repeated for each of the attention layers.

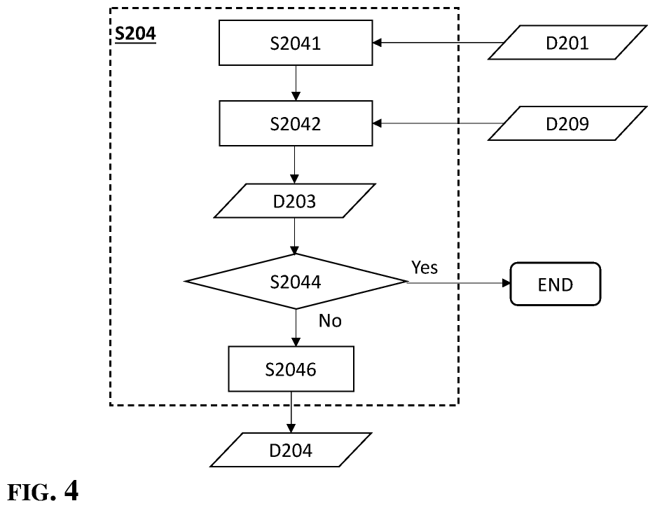

FIG. 4 illustrates a flowchart of the generation of attention pattern proposal S204 in accordance to one preferred embodiment. As shown, the generation of attention pattern proposal S204 comprises the following process steps:

S2041: identifying the spatial, temporal, and/or contextual characteristics/patterns of the input elements D201 based on the features extracted from the input elements D201;

S2042: visualizing the attention layer 301 to identify the original attention mask pattern D203 based on the attentions being placed in relation to the identified spatial, temporal, and/or contextual characteristics/patterns of the input elements D201 and one or more original prediction results D209;

S2044: determining whether the original attention mask pattern D203 makes intuitive sense by a human observer, that is whether attentions are being placed correctly and with appropriate attention weights in relation to the identified elements of the input elements D201 and the original prediction results D209; and

S2046: if the original attention mask pattern D203 does not make intuitive sense, creating the proposed attention mask pattern D204 based on one or more desired attention placements and weights on the input elements D201. The proposed attention mask pattern D204 may be one of a plurality of attention mask patterns each having different set of desired attention placement(s) and weight(s); thus, a plurality of attention pattern proposals is possible.

It should be understood that various types of attention pattern proposals may be created depending on the nature of the prediction model and the input elements. For example, the input elements D201 may include spatial features such as text images for the workflow-based neural network 300 to predict the words and phrases; or the input elements D201 may include temporal features for the predictions of textual character(s) per timestep; or the input elements D201 may include contextual features for the predictions of natural language translation.

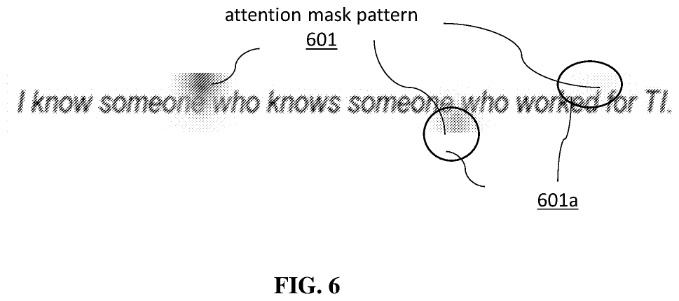

The inventive concept of the process step S2044 is illustrated by example with reference to FIG. 6. Assuming the workflow-based neural network 300 is trained to predict a character per timestep from input elements D201 having temporal features, and assuming the input elements D201 are text images appearing as: “I know someone who knows someone who worked for TI.”). In the unoptimized workflow-based neural network 300's prediction of the first occurrence of the character “w”, the original attention mask pattern is shown having the attention placements 601. By visualization, it can be seen that the attention placements 601a are incorrect. Thus, the original attention mask pattern D203 of the attention layer of makes no intuitive sense.

In the aforementioned example, the original attention mask pattern D203 on input elements D201 having temporal features does not make intuitive sense. A proposed attention mask pattern hence may be one having an attention placement on a single timestep. Another proposed attention mask pattern D204 may be one having attention placements shifted forward (or to the right) by some small distance for each timestep.

In one embodiment, a proposed attention mask pattern may be one that needs to attenuate the attention weights that are far away from the centroid of the attention weights. In this case an attention mask updating function ƒ may be defined as:

$$f ( {W}_{t} ) = \{ \begin{matrix}e = 0 if abs ( {e}_{x} - {c}_{t - 1} ) > threshold ∀ e ∈ W \\ e = e if abs ( {e}_{x} - {c}_{t - 1} ) \leq threshold ∀ e ∈ W\end{matrix}$$

where

$${W}_{t} = softmax ( \frac{Q {K}^{T}}{\sqrt{d}} )$$

represents the attention weights at time t, cₜ₋₁ is the attention weight of the centroid of Wₜ₋₁, eₓ is the attention weight on an element at x-distance from the centroid, and threshold is a pre-defined difference in attention weight threshold value.

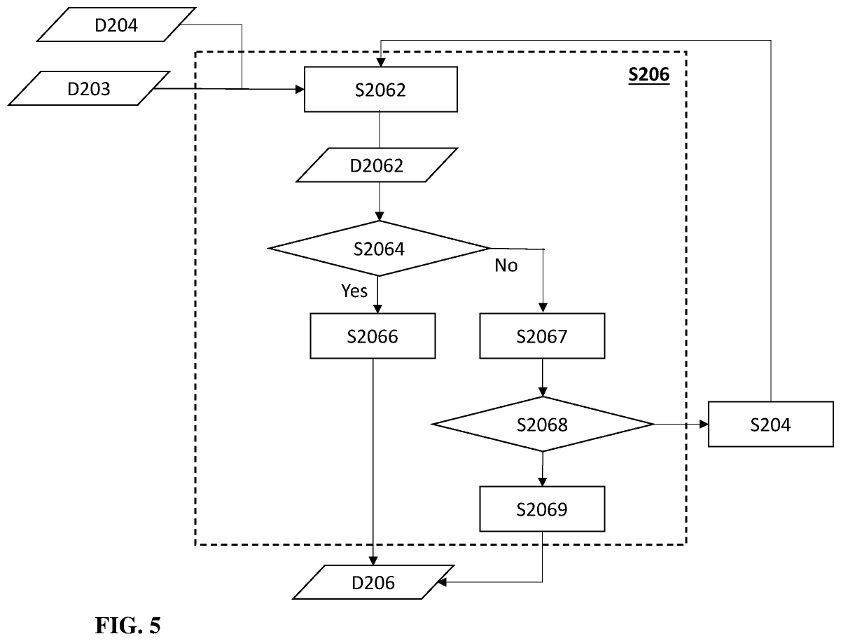

FIG. 5 illustrates a flowchart of creation of the attention mask updating function S206 in accordance to one preferred embodiment, which comprises the following process steps:

S2062: designing a deviation function to obtain a deviation value D2062 representing the quantifiable deviation between the original attention mask pattern D203 deviates and the proposed attention mask pattern D204;

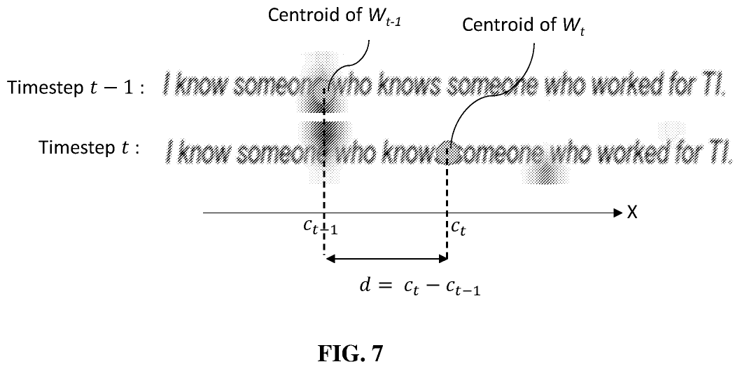

The inventive concept of the deviation function is illustrated by example with reference to FIG. 7. As shown in FIG. 7, a distance d in the x-direction between a centroid cₜ₋₁ of attention weights Wₜ₋₁ at previous timestep t−1 and a centroid cₜ of attention weights Wₜ at current timestep t (that is, d=cₜ−cₜ₋₁) may be obtained and used as a deviation value to evaluate how the original attention mask pattern D203 deviates from the proposed attention mask pattern D204.

S2064: determining whether an attention mask updating function can be created to fulfill the attention pattern proposal; that is, whether the original attention mask pattern D203 can be manipulated so that an updated attention mask pattern can be obtained to approach or violate to a lesser extent from the proposed attention mask pattern D204; in other word, the attention mask updating function is created based on the deviation function; if the deviation function cannot be designed, or that the deviation function cannot be expressed concretely with mathematical expression, the attention mask updating function cannot be created;

S2066: if the attention mask updating function D206 can be created to fulfill the proposed attention mask pattern D204, creating the attention mask updating function D206;

S2067: if the attention mask updating function D206 cannot be created to fulfill the proposed attention mask pattern D204, considering the generation of a new attention pattern proposal by executing the process step S204;

S2068: determining whether a new attention pattern proposal can be obtained, and if so, reiterating the executions of the process steps beginning from the process step S204;

S2069, if a new attention pattern proposal cannot be obtained, adopting a reinforcement learning (RL) model as the attention mask updating function D206.

In one embodiment, the deviation function is used as a part of reward in the RL model, and one or more loss results from the original prediction model of the workflow-based neural network 300 are used as another part of the reward in the RL model. Actions available to an agent in the RL model are designed so as to limit the size of the action set. The actions may include changing one or more of the attention placements and weights.

### EXPERIMENTS

Performance of an exemplary workflow-based neural network which was optimized with methods for optimizing a workflow-based neural network in accordance with the embodiments of the present invention has been evaluated in an experiment conducted. The exemplary workflow-based neural network includes a residual network (ResNet50) and vanilla transformer decoder layers. The workflow-based neural network's prediction model was trained to perform an optical character recognition task to output characters from input with text images having variable width. 780,000 English news sentences and synthesized printed English text with more than 100 font types are used as the training dataset. Cross entropy performance of the original (unoptimized) prediction model, the prediction model optimized in inference and the prediction model optimized through further training were tested with a testing dataset of 10,000 non-synthesized text images and measured by a cross entropy loss function. Table 1 shows the performance of the exemplary workflow-based neural network in terms of word error rate (WER) and character error rate (CER). As shown, the model optimized with the method provided by the present invention has lower WER and CER than the pretrained model.

TABLE 1
Comparison of performance of the original (pretrained) model, refined
model in inference and optimized model through further training.

| Metrics on | Original | Optimized in | Optimized model |
|---|---|---|---|
| Test set | (Pretrained) | inference | through training |
| Word Error | 14.33% | 11.94% | 9.89% |
| Rate (WER) | | | |
| Character Error | 6.52% | 4.02% | 2.27% |
| rate (CER) | | | |

The embodiments disclosed herein may be implemented using computing devices, computer processors, or electronic circuitries including but not limited to application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

All or portions of the embodiments may be executed in one or more general purpose or computing devices including server computers, personal computers, laptop computers, mobile computing devices such as smartphones and tablet computers.

The embodiments include computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Various embodiments of the present invention also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A method for optimizing a workflow-based neural network including an attention layer, the method comprising:
training the workflow-based neural network to predict one or more results from one or more input elements under a prediction model with the attention layer assigning one or more attention placements and weights, based on an original attention function of the attention layer, to the input elements until the prediction model converges;
generating an attention mask pattern proposal to obtain an original attention mask pattern and a proposed attention mask pattern;
creating an attention mask updating function based on the original attention mask pattern and the proposed attention mask pattern; and
combining the attention mask updating function with the original attention function to form an updated attention function of the attention layer.

2. The method according to claim 1, wherein the generation of attention pattern proposal comprising:
identifying one or more elements of the input elements based on one or more features extracted from the input elements;
visualizing the attention layer to identify the original attention mask pattern based on one or more attentions being placed by the attention layer in relation to the identified elements of the input elements and one or more original prediction results;
determining whether the original attention mask pattern makes intuitive sense, comprising:
determining whether the attentions are being placed correctly and with appropriate attention weights in relation to the identified elements of the input elements and the original prediction results; and
creating the proposed attention mask pattern based on one or more desired attention placements and attention weights on the input elements if the original attention mask pattern does not make intuitive sense.

3. The method according to claim 1, wherein the creation of the attention mask updating function comprising:
designing a deviation function to obtain a deviation value representing a quantifiable deviation between the original attention mask pattern deviates and the proposed attention mask pattern;
determining whether an attention mask updating function can be created to fulfill the attention pattern proposal;
creating the attention mask updating function if the attention mask updating function can be created to fulfill the proposed attention mask pattern;
considering a generation of a new attention pattern proposal if the attention mask updating function cannot be created to fulfill the proposed attention mask pattern; and
adopting a reinforcement learning (RL) model as the attention mask updating function if the attention mask updating function cannot be created to fulfill the proposed attention mask pattern and if a new attention pattern proposal cannot be obtained.

4. The method according to claim 1, wherein the combining of the attention mask updating function with the original attention function to form the updated attention function of the attention layer comprises:
training the workflow-based neural network to learn through backpropagation with an auxiliary loss function defined with the original attention function and the attention mask updating function.

5. The method according to claim 1, wherein the combining of the attention mask updating function with the original attention function to form the updated attention function of the attention layer comprises:
directly applying the attention mask updating function to the original attention mask pattern in the attention layer.

6. The method according to claim 1,
wherein the original attention function is a scaled dot-product attention function having input including a key matrix of queries and a key matrix of keys, both of a dimension dₖ, and a value matrix of values;
wherein the attention weights are obtained by computing dot products of the queries and the keys, then dividing each of the dot products by a square root of dₖ;
wherein the obtained attention weights are applied to the values to obtain the attention function.

7. The method according to claim 6, wherein the original attention function is expressed as:
$$Attention ( Q , K , V ) = softmax ( \frac{Q {K}^{T}}{\sqrt{{d}_{k}}} ) \cdot V ;$$
wherein Q represents a key matrix of queries, K represents a key matrix of keys, dₖ represents a dimension of both the key matrix of queries and the key matrix of keys, and V represents a value matrix of values; and
wherein the updated attention function is expressed as:
$${Attention}^{′} ( Q , K , V ) = f ( softmax ( \frac{Q {K}^{T}}{\sqrt{d}} ) ) \cdot V ;$$
wherein ƒ( ) represents the attention mask updating function.

8. The method according to claim 7, wherein the attention mask updating function is expressed as:
$$f ( {W}_{t} ) = \{ \begin{matrix}e = 0 if abs ( {e}_{x} - {c}_{t - 1} ) > threshold ∀ e ∈ W \\ e = e if abs ( {e}_{x} - {c}_{t - 1} ) \leq threshold ∀ e ∈ W\end{matrix}$$
where Wₜ represents attention weights at time t, cₜ₋₁ is an attention weight of a centroid of Wₜ₋₁, eₓ is an attention weight on an element at x-distance from the centroid, and threshold is a pre-defined difference in attention weight threshold value.

9. A workflow-based neural network including an attention layer;
wherein the workflow-based neural network is trained to predict one or more results from one or more input elements under a prediction model with the attention layer assigning one or more attention placements and weights, based on an original attention function of the attention layer, to the input elements until the prediction model converges; and
wherein the attention layer having an original attention function that is updated to form an updated attention layer by:
generating an attention mask pattern proposal to obtain an original attention mask pattern and a proposed attention mask pattern;
creating an attention mask updating function based on the original attention mask pattern and the proposed attention mask pattern; and
combining the attention mask updating function with the original attention function to update the original attention function to form the updated attention layer.

10. The workflow-based neural network according to claim 9, wherein the generation of attention pattern proposal comprising:
identifying one or more elements of the input elements based on one or more features extracted from the input elements;
visualizing the attention layer to identify the original attention mask pattern based on one or more attentions being placed by the attention layer in relation to the identified elements of the input elements and one or more original prediction results;
determining whether the original attention mask pattern makes intuitive sense, comprising:
determining whether the attentions are being placed correctly and with appropriate attention weights in relation to the identified elements of the input elements and the original prediction results; and
creating the proposed attention mask pattern based on one or more desired attention placements and attention weights on the input elements if the original attention mask pattern does not make intuitive sense.

11. The workflow-based neural network according to claim 9, wherein the creation of the attention mask updating function comprising:
designing a deviation function to obtain a deviation value representing a quantifiable deviation between the original attention mask pattern deviates and the proposed attention mask pattern;
determining whether an attention mask updating function can be created to fulfill the attention pattern proposal;
creating the attention mask updating function if the attention mask updating function can be created to fulfill the proposed attention mask pattern;
considering a generation of a new attention pattern proposal if the attention mask updating function cannot be created to fulfill the proposed attention mask pattern; and
adopting a reinforcement learning (RL) model as the attention mask updating function if the attention mask updating function cannot be created to fulfill the proposed attention mask pattern and if a new attention pattern proposal cannot be obtained.

12. The workflow-based neural network according to claim 9, wherein the combining of the attention mask updating function with the original attention function to form the updated attention function of the attention layer comprises:
training the workflow-based neural network to learn through backpropagation with an auxiliary loss function defined with the original attention function and the attention mask updating function.

13. The workflow-based neural network according to claim 9, wherein the combining of the attention mask updating function with the original attention function to form the updated attention function of the attention layer comprises:
directly applying the attention mask updating function to the original attention mask pattern in the attention layer.

14. The workflow-based neural network according to claim 9,
wherein the original attention function is a scaled dot-product attention function having input including a key matrix of queries and a key matrix of keys, both of a dimension dₖ, and a value matrix of values;
wherein the attention weights are obtained by computing dot products of the queries and the keys, then dividing each of the dot products by a square root of dₖ;
wherein the obtained attention weights are applied to the values to obtain the attention function.

15. The workflow-based neural network according to claim 14, wherein the original attention function is expressed as:
$$Attention ( Q , K , V ) = softmax ( \frac{Q {K}^{T}}{\sqrt{{d}_{k}}} ) \cdot V ;$$
wherein Q represents a key matrix of queries, K represents a key matrix of keys, dₖ represents a dimension of the key matrix of queries and the key matrix of keys, and V represents a value matrix of values; and
wherein the updated attention function is expressed as:
$${Attention}^{′} ( Q , K , V ) = f ( softmax ( \frac{Q {K}^{T}}{\sqrt{d}} ) ) \cdot V ;$$
wherein ƒ( ) represents the attention mask updating function.

16. The workflow-based neural network according to claim 15, wherein the attention mask updating function is expressed as:
$$f ( {W}_{t} ) = \{ \begin{matrix}e = 0 if abs ( {e}_{x} - {c}_{t - 1} ) > threshold ∀ e ∈ W \\ e = e if abs ( {e}_{x} - {c}_{t - 1} ) \leq threshold ∀ e ∈ W\end{matrix}$$
where Wₜ represents attention weights at time t, cₜ₋₁ is an attention weight of a centroid of Wₜ₋₁, eₓ is an attention weight on an element at x-distance from the centroid, and threshold is a pre-defined difference in attention weight threshold value.
